(19) United States
(12) Patent Application Publication
(10) Pub. No.: US 2004/0130286 A1
(43) Pub. Date: Jul. 8, 2004

(54) Reluctance motor and a method for controlling a reluctance motor

(76) Inventors: Uwe Caldewey, Dortmund (DE); Markus Schiffarth, Schwelm (DE); Volker Schmitz, Solingen (DE); Stefan Hilgers, Essen (DE)

Correspondence Address: Martin A Farber, Suite 473, 866 United Nations Plaza, New York, NY, 10017, US

(21) Appl. No.: 10/240,332

(22) PCT Filed: Mar. 29, 2001
(86) PCT No.: PCT/EP01/03596

(30) Foreign Application Priority Data
Apr. 1, 2000 (DE) 10016396.3
Jul. 21, 2000 (DE) 10035540.4

(51) Int. Cl. H02P 5/28

(52) U.S. Cl. 318/701

(57) ABSTRACT

A method for controlling a reluctance motor comprising a rotor (1) and a stator (10), the stator (10) having individual stator coils (22) and a predefined current flowing in the coils (22) according to loading of the motor, the method comprising the steps of applying different control methods depending on number of revolutions of the rotor (1), namely by prescribing a fixed rotary field with smaller number of revolutions.

The invention relates in the first instance to a method for controlling a reluctance motor comprising a rotor and a stator, the stator having individual stator coils and a predefined current flowing in the coils according to the loading of the motor.

In the case of switched reluctance motors, which are generally known, the size of the torque depends on the position of the rotor in relation to the stator field. To achieve the maximum torque in the motor, the stator currents, and consequently the stator field, have to be controlled according to the rotor position.

With regard to the previously mentioned prior art, a perceived technical problem with which the invention is concerned is that of advantageously developing a reluctance motor, in particular with respect to its activation.

This problem is solved in the first instance and to a substantial extent by the subject matter of claim 1, it being provided that different control methods are applied, depending on the number of revolutions of the rotor, to be specific by prescribing a fixed rotary field when the number of revolutions is relatively small. In particular in the case of reluctance motors which have a large rotational speed range, it is no longer adequate to use a standard control method. Rather, range-dependent control is required. In particular at very low rotational speeds, of for example about 100 revolutions per minute, prescribing a fixed rotary field in the way provided by the invention proves to be advantageous. At higher rotational speeds, of for example >400 rpm, a current hysteresis control method is applied according to the invention, with furthermore an adaptation of the control parameters being preferred. It further proves to be particularly advantageous that, when prescribing a rotary field, the rotor current is adapted or reduced to an adequate value. For higher numbers of revolutions of the reluctance motor, it is provided that, with the current hysteresis control method applied in this case, the windings are switched on and off by means of sensors detecting the rotor position. Furthermore, it may be provided with regard to the current hysteresis control method that the predefined current is achieved by impressing on a constant voltage and that, when the voltage is impressed, the time it takes to reach the maximum current value is measured, as a measure of the loading of the motor. The inductance of a stator coil is dependent, inter alia, on the air gap between the rotor and stator. This results in a constant change in the inductance during a revolution of the rotor. Under loading, the angle between the rotor and the stator field is displaced, which has the consequent result of a reduction in the inductance in the stator coil when the voltage is switched on. According to the invention, this change is registered in the current hysteresis control method. For this purpose, it is proposed furthermore that the predefined current is retained by switching a positive voltage off and on. The current in the stator coil is preferably controlled by the pulse-width modulation method. In the case of this method, the coils are alternately switched to a positive and negative constant voltage. The current increases with the positive voltage and, conversely, drops with the negative voltage. The timing ratio between the current increase and current drop gives the resultant desired current level in the respective coil. In the present current hysteresis control method, a current is impressed at a defined level, by the positive voltage being switched to the coil for as long as it takes before a maximum value is exceeded. After that, the voltage is alternately switched off and on, to obtain the predefined current value. The time which passes from when the voltage is switched on to when the maximum value is reached is dependent on the inductance. Under loading, the inductance at the switching-on time is reduced. This change can be used to determine the loading of the motor between switching on the voltage and the signal that the maximum current has been reached. In a development of the method, it is provided that, when a limit current for preventing a motor overload is reached, a reduction in rotational speed takes place. After that, the reduction in rotational speed preferably takes place at a maximum current value that specifically also marks the upper limit of the loading capacity and in this respect is referred to as a limit current. To avoid overloading of the motor, the rotational speed can accordingly be reduced when the load is too high. It is further proposed for the time measurement to take place by starting an internal counter when the voltage is switched on and stopping the counter when a maximum current value is exceeded. This time measurement may be realized in the simplest way by a microcontroller control. In this case it further proves to be advantageous that, triggered by reaching a minimum counter value, a rotational speed reduction is controlled. In addition, it is proposed that a control of the stator currents takes place according to the measured time, with the predefined current also being variable. Moreover, it is proposed that the predefined current is steplessly variable, and that the control of the stator currents takes place by means of a converter. With regard to the configuration described above of a current hysteresis control method according to the invention, you are referred for further details to DE-A1 198 25 926. The content of this patent application is hereby incorporated in full in the disclosure of the present invention, including for the purpose of incorporating features of this patent application in claims of the present invention. For registering the position of the rotor, it is provided in an advantageous development of the method that the rotor position is determined by means of a reflected light barrier, the light source being disposed in the stator and the reflection of the rotor being used directly for measurement by alignment with the rotor. It further proves to be advantageous in this respect that a position sensor is provided for each phase. Consequently, in the case of a three-phase motor for example, three position sensors are correspondingly provided, at least as long as in each position of the rotor the corresponding phase is to be supplied with current (with the exception of small numbers of revolutions and associated control methods by prescribing a fixed rotary field). For detecting the position, reflected light barriers may be used. In an advantageous way, these reflected light barriers are directed straight at the rotor, so that tolerances of a sensor disk and its angular offset are automatically eliminated. When starting the reluctance motor, load-torque-dependent oscillations may occur. This occurs as soon as there is a switchover from one phase to the next. If the load torque is great, the new position is not reached; rather, the rotor is turned back by the counter-force. On account of the low mass of the rotor, oscillating may therefore occur between these two states. The backward turning of the rotor can be detected by the control electronics, at least if there is a position sensor for each phase.. According to the invention, it is proposed in this respect that no phase is supplied with current any longer when backward turning of the rotor commences. As a consequence of this, a renewed starting operation is initiated when backward turning of the rotor is detected by the electronics. It may alternatively be provided that, when backward turning is initiated, the last phase is supplied with current for an extended period. In both forms of the method, an improvement in the starting behavior is achieved. In particular, the oscillating at a phase switchover point is reliably suppressed.

The invention relates furthermore to a method for controlling a reluctance motor comprising a rotor and a stator, the stator having individual stator coils and a predefined current flowing in the coils according to the loading of the motor. Here it is provided in an advantageous way for further development of a method in question that a temperature registration by means of a temperature sensor takes place at the stator winding. In comparison with a universal motor, the efficiency profile over the entire rotational speed range is made much more uniform. It is, also the case under maximum loading, in particular in the low rotational speed range, that an inadmissibly high winding temperature is reached if no additional cooling measures are provided. To prevent overheating, the temperature registration according to the invention is provided at the stator winding, with it being further preferred for the temperature sensor to be an NTC. By means of the latter, which is preferably disposed directly on the stator assembly, the temperature is registered. On this basis, the reluctance motor can be correspondingly influenced by means of the electronics, for example by switching off the motor or by limiting the phase current when a temperature limit is exceeded, which results in overload protection in a simple way.

Moreover, the invention relates to a method for controlling a reluctance motor comprising a rotor and a stator, the stator having individual stator coils and a predefined current flowing in the coils according to the loading of the motor. To develop a method of the type in question in an advantageous way, it is proposed that the motor can be driven both counterclockwise and clockwise. As a consequence of this, a control method for a reluctance motor is specified, a method which makes it possible, for example when the motor is used in a food processor with an agitator for preparing food, for novel recipes to be devised in an advantageous way by changing the direction of rotation.

To make it possible for the motor to be slowed down quickly when it is switched off and/or when the current supply to the motor is interrupted, even from high rotational speeds, it is provided in the first instance that the braking energy or the rotational energy of the rotor is used for operating the motor as a generator. Furthermore, braking of the motor may take place according to the invention by supplying current to all phases simultaneously. A method for braking the motor comprising a combination of generator operation and simultaneous supply of current to all phases is preferred, with a continual alternation between the two braking methods being performed by a microcontroller until the motor comes to a standstill.

The invention also relates to a reluctance motor comprising a rotor and a stator, the stator having individual stator coils and the rotor having wing-like rotor segments. To develop a reluctance motor of the type in question in an advantageous way, in particular with regard to a reduction in the sound emission, it is provided that the gaps between the wing-like rotor segments are filled to create a cylinder body. A major problem with reluctance motor is the sound emission at high rotational speeds. Owing to the open form of construction of the rotor and the small air gap, the motor acts in the manner of a siren as soon as a rotor pole draws past a stator pole. This is remedied here by the way in which the rotor surface is made more homogeneous by the invention. This is achieved by filling the gaps in the rotor by means of corresponding filling segments. They are used to give the rotor a cylindrical form, whereby pressure variations during rotation of the rotor are effectively suppressed in the stator, so that the noise emission is distinctly reduced. The segments can at the same time also be used for balancing the rotor. A configuration in which the filling takes place by means of two cladding parts which can be axially fitted together and have filling segments is preferred for this. It may specifically be provided in this respect that a cladding part has filling body segments extending from a circular disk part, with the diameter of the circular disk part preferably being adapted to the rotor diameter and the filling body segments being formed in such a way that they are adapted to correspond to the gaps between the rotor segments. It is further proposed for the filling body segments to be plastics parts. When the segments are formed as molded parts of plastic, the surfaces can be configured in any desired form or structure. Furthermore, by suitable forming of the filling body segments, a type of cooling fan can be created. To reduce the noise emission further, it is proposed for the gap between the stator windings to be filled by a stator covering body, it further being proposed for the stator covering body to be formed as a cylinder. In an alternative configuration of the subject matter of the invention, it is provided that the stator windings are covered on the rotor side, with the gap between the stator windings being covered over, it being further preferred for a plurality of stator covering bodies to be provided, making up a cylinder on the rotor side.

This configuration according to the invention also achieves the effect of making the surfaces in the motor more homogeneous, so that the air gap remains virtually constant over the entire circumference. If a solution with individual coil formers is preferred, the inner side of the stator can be fashioned by forming appropriate rounded portions on it in such a way that the required round inner contour is produced. To specify a solution in which collision-free mounting of the individual coil formers or stator covering bodies is achieved, it is proposed for stator covering bodies with rotor-side cover segments of different sizes, covering over the gap between the stator windings, to be provided, with the rounded portions on one coil former or stator covering body filling a greater segment than the neighboring one. For securing these stator covering bodies or coil formers, latching hooks which securely latch onto the stator core or housing, so that a mechanical arrestment takes place, may be integrally formed on these bodies. When the bearing bridges for the rotor are mounted, these latching hooks are additionally secured against slipping. Moreover, it is provided that the stator covering body has windows, in which the metallic winding cores are exposed on the rotor side. To allow the motor to be produced as simply as possible, a suitable winding technique is required. It is customary to wind individual coils on a coil former and subsequently mount each individual one in the stator. However, it is also possible to push a complete coil former with all the coils at one and the same time into the stator. In this respect it is proposed for the stator covering body to have wound core shoes, which carry the windings. The stator covering body accordingly serves at the same time as a coil former, which is wound in a way similar to in the case of a rotor of a universal motor. The complete former is subsequently inserted into the stator, for which purpose it is,provided in an advantageous way that the windings are formed on one side such that they protrude into the interior of the space bounded by the stator. For this purpose, winding overhangs angled away into the interior of the space bounded by the stator are provided on the stator covering body or coil body. To simplify the construction of the motor further, in particular the mounting of the same, it is provided in an advantageous development of the subject matter of the invention that the stator covering body has formed or attached on one side of it a bearing receptacle for the rotor. In the course of further simplification of the reluctance motor, it is also appropriate to perform the contacting of the same without cables. In this respect it is proposed for a bow spring contact, which is contacted directly by the winding on the bottom side, to be attached to the wound core shoe. It is consequently possible in an advantageous development for this bow spring contact to contact a printed circuit board on the upper side, with said printed circuit board being connected by a suitable latching mechanism to the motor or to the bridge forming the bearing receptacle. Apart from this indirect contacting, a solution in which the winding has contacts which directly contact a printed circuit board is also proposed. In one configuration of the subject matter of the invention, it is proposed that each winding has two terminal pins, which contact with a printed circuit board, with furthermore the printed circuit board being aligned parallel to the rotor laminations. What is known as a leadframe, which in the first instance comprises a conventional PCB, is consequently specified for the definitive interconnection of the stator coils. The windings in the motor have in each case as a terminal two wire pins, which are connected to the beginning of the winding and the end of the winding, respectively. These terminals protrude beyond the coils, so that they can enter into the printed circuit board, which latter lies parallel to the rotor or stator laminations. In this respect, it is further provided that the printed circuit board is disposed in a rotationally fixed manner between the rotor and a bearing receptacle for the rotor and consequently lies within the motor. On the printed circuit board there are conductor tracks, which connect the coils to one another in a directly automatic and definitive manner when the printed circuit board is mounted in the motor. It further proves to be advantageous here for the printed circuit board to have a circular disk-shaped base outline with a terminal portion protruding outward beyond the stator core, the circular disk-shaped base outline being adapted in diameter to the inside diameter of the stator core. In the region of the outwardly protruding terminal portion there can be disposed a PCB edge connector, by means of which the pairs of coils can be definitively identified. Moreover, on the PCB there is a sensor system, which, in the case of a three-phase motor in the configuration of six stator poles and four rotor poles, may comprise two or three forked light barriers. The use of reflected light barriers as sensors is also conceivable. These light barriers are in known angular relationship with the individual coils, so that it is no longer possible for the in-phase association of the sensor signals to be incorrectly set up. In the case of a three-phase motor, there is, furthermore, the possibility of using a 180° symmetry, i.e. two possible mounting positions exist with respect to the stator, both of which are valid. In the case of a round outer contour of the stator, six mounting positions are also consequently possible. The terminals of the coils are used at the same time to align the printed circuit board, with the terminals being soldered to the printed circuit board after mounting. The signals of the sensor system are likewise applied to the edge of the printed circuit board, so that here, too, the connection with the electronics can again be established by means of a PCB edge connector or the like. Since the printed circuit board area of the leadframe is made relatively large, according to the inside diameter of the stator, it is further conceivable to integrate the entire electronics, or at least parts thereof, on the printed circuit board. This at the same time offers the advantage of very short conductor track routing, so that EMC disturbances are avoided or at least reduced. It further proves to be particularly advantageous for the printed circuit board to have the position sensors for the rotor. Moreover, it may be provided that the printed circuit board has the direction-changing electronics for the counterclockwise and clockwise driving of the motor. It also proves to be advantageous for a holding disk of the rotor laminations to be formed as a sensor disk for the determination of the rotor position. For this purpose, the holding disk of the rotor laminations is formed cylindrically on as large an outer radius as possible, on which cylinder suitable segments of a circle are removed. The cylindrical sensor disk rotates through the light barriers, which are located on the leadframe or on the printed circuit board, it being preferred for this purpose for the sensor disk to be disposed on the rotor such that it faces the printed circuit board. This sensor disk has in this case a uniquely defined association with the position of the rotor.

Since the position of the rotor is in this case definitively determined by the bearing bridges having the bearing receptacles for said rotor, the distance between the sensor disk and the printed circuit board is, likewise automatically set. In an advantageous development of the subject matter of the invention, it is provided that a holding disk of the rotor laminations is formed as a cooling fan, which latter is formed on the end of the rotor remote from the printed circuit board. As a consequence of this configuration, this holding disk, like the holding disk described above, undertakes a dual function.

The invention is explained in more detail below on the basis of the accompanying drawing, which merely represents exemplary embodiments and in which:

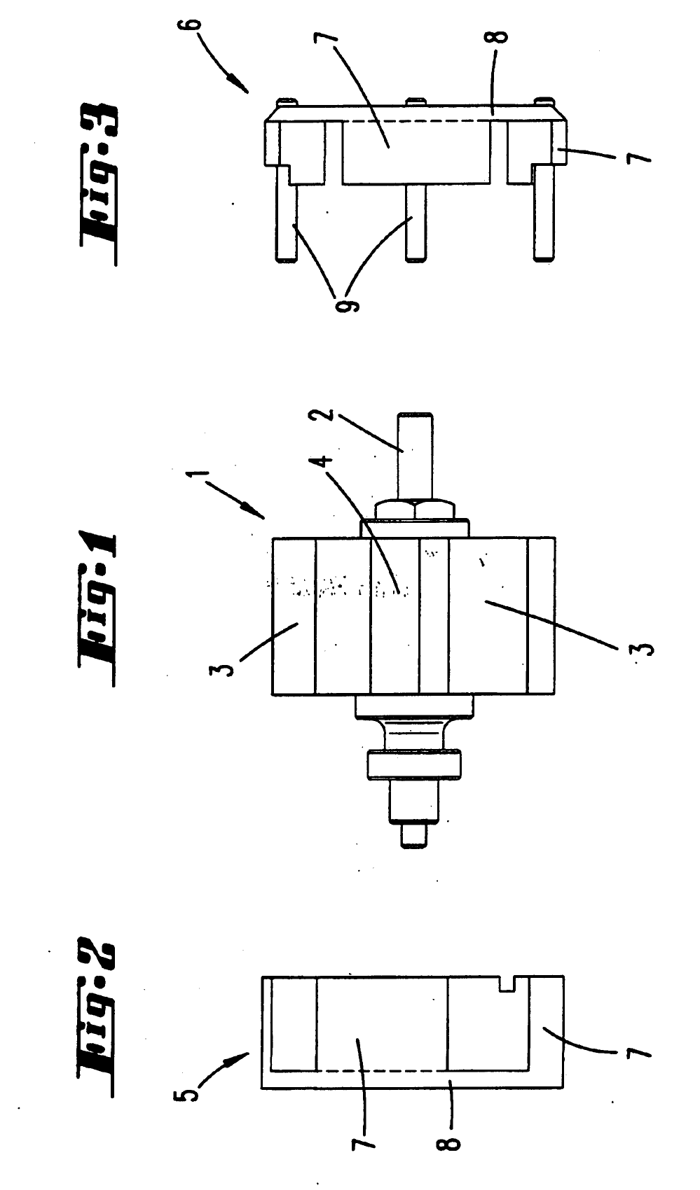

FIG. 1 shows a side view of a rotor for a reluctance motor according to the invention;

FIG. 2 shows a side view of a cladding part which can be associated with the rotor according to FIG. 1;

FIG. 3 shows a side view of a further cladding part, which can be axially fitted together with the cladding part according to FIG. 2, for being disposed on the rotor according to FIG. 1;

FIG. 4 shows the end view toward the rotor;

FIG. 5 shows the end view toward the cladding part according to FIG. 2;

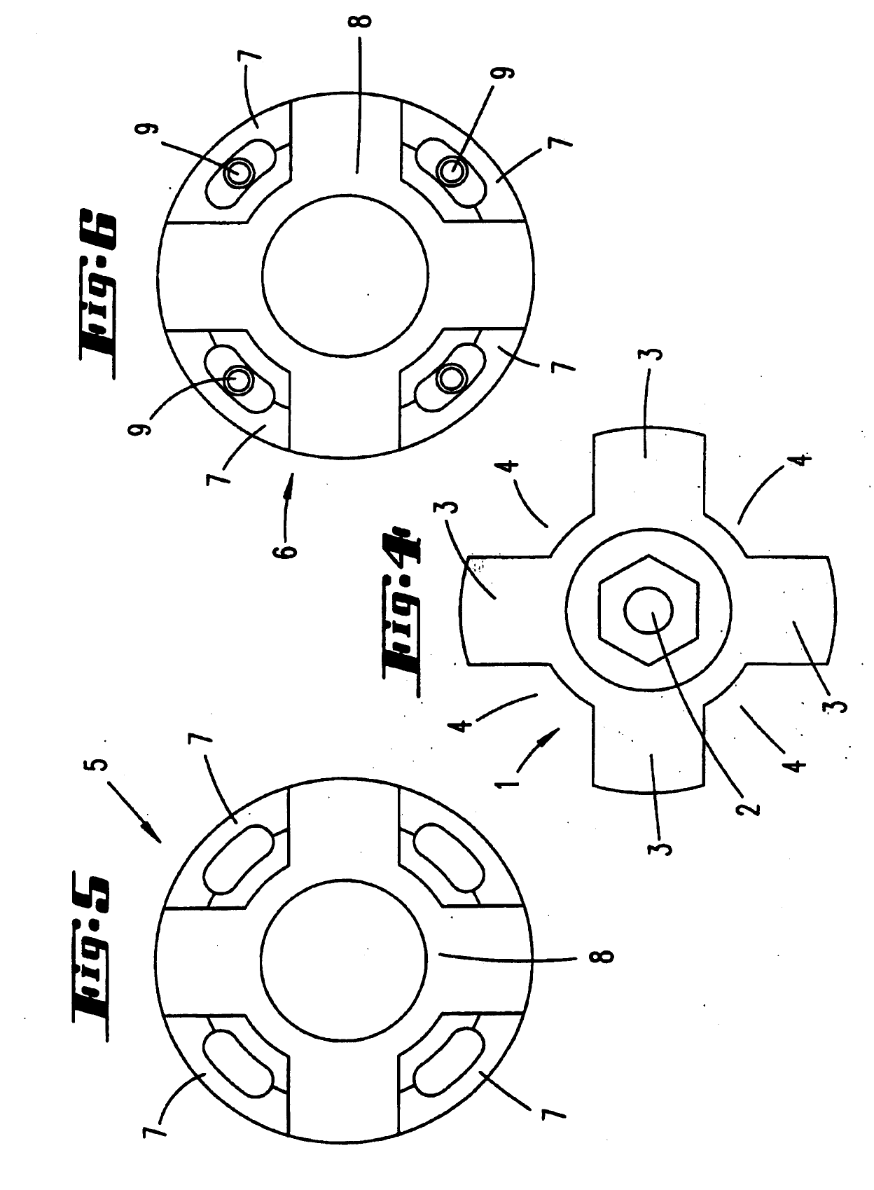

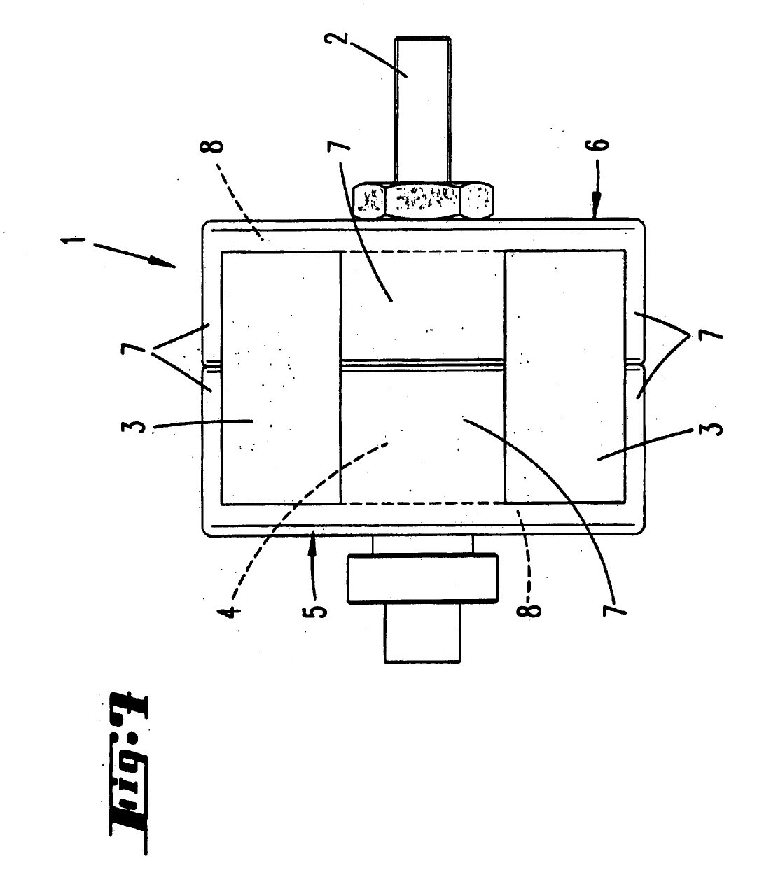

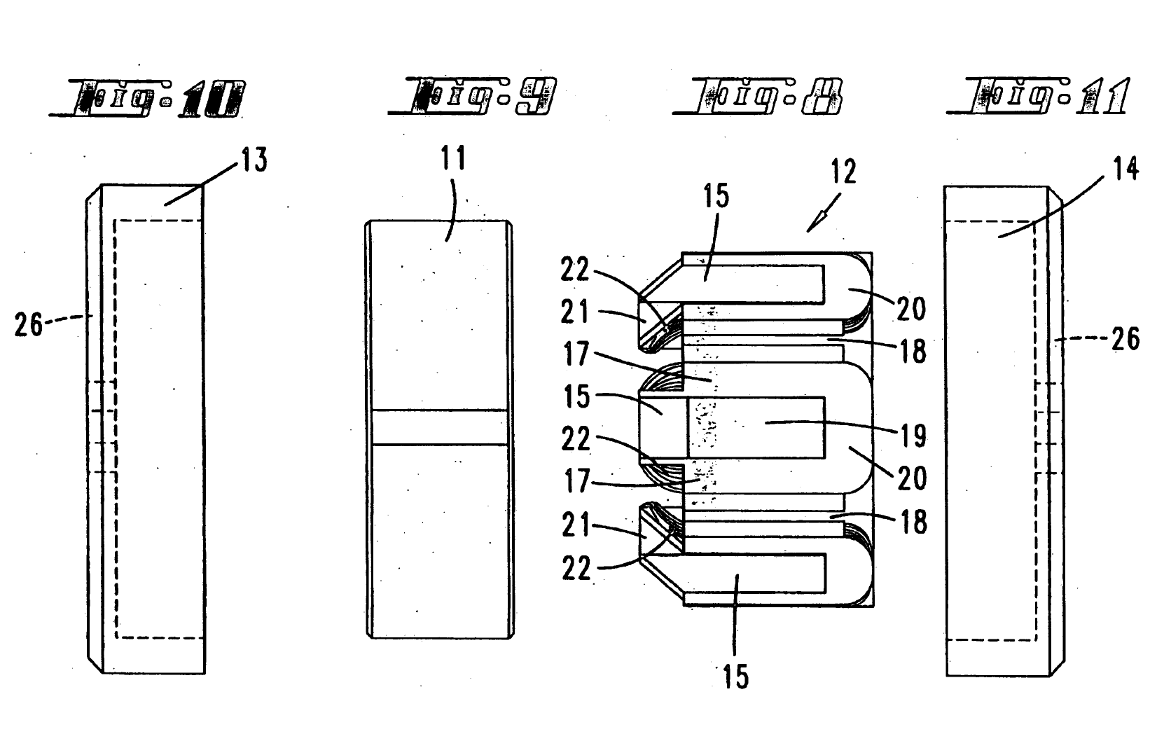

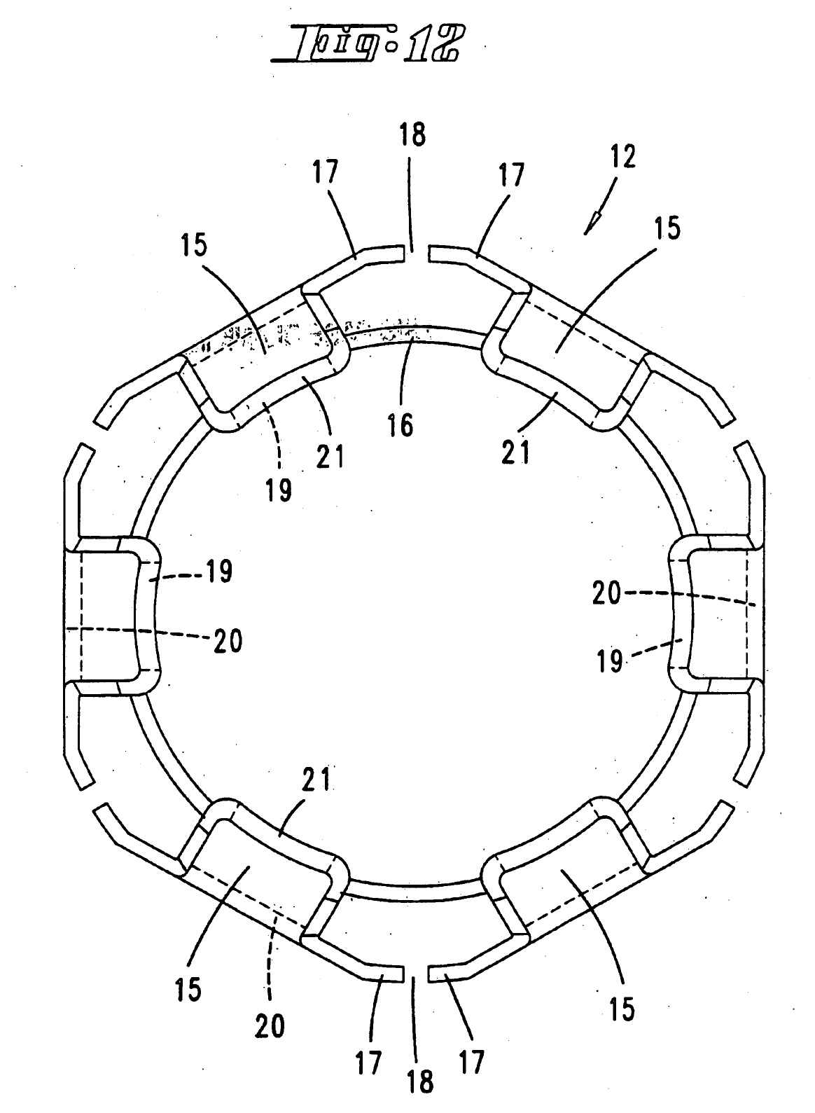

FIG. 6 shows the end view toward the cladding part according to FIG. 3;

FIG. 7 shows an assembly representation of the rotor provided with the cladding parts;

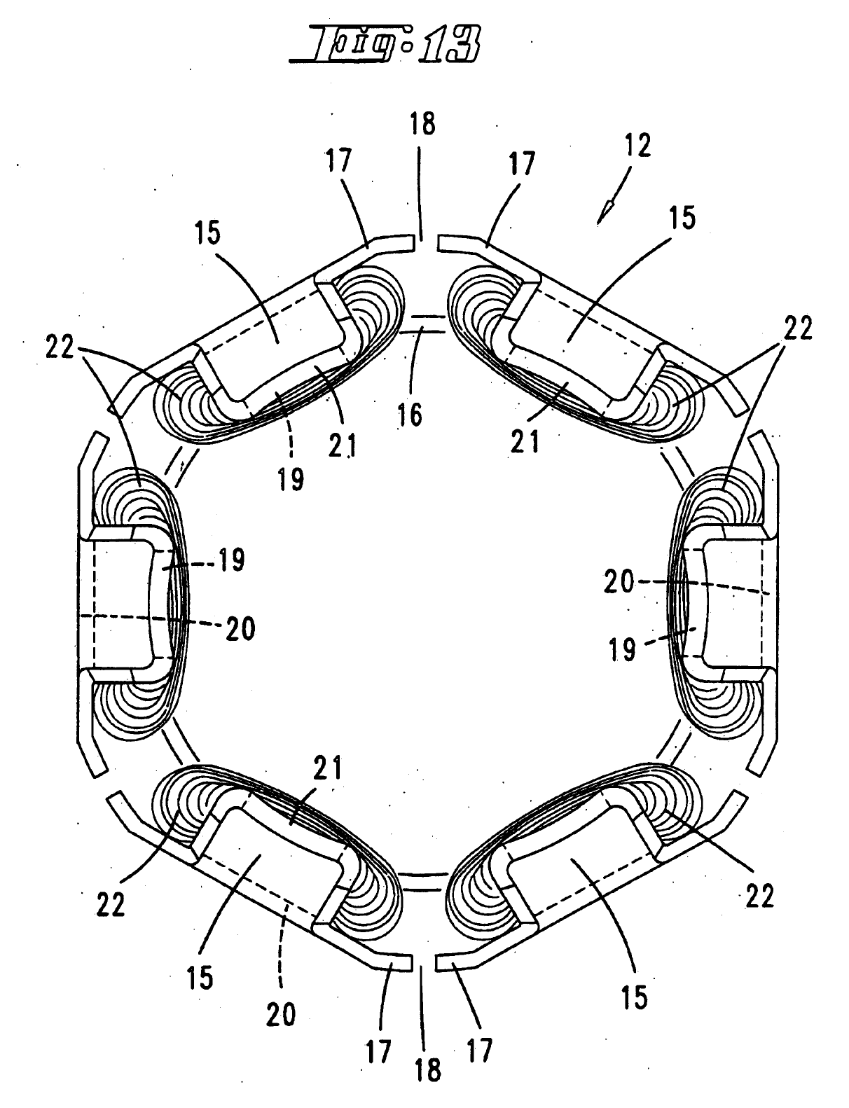

FIG. 8 shows a side view of a stator covering body provided with stator coils;

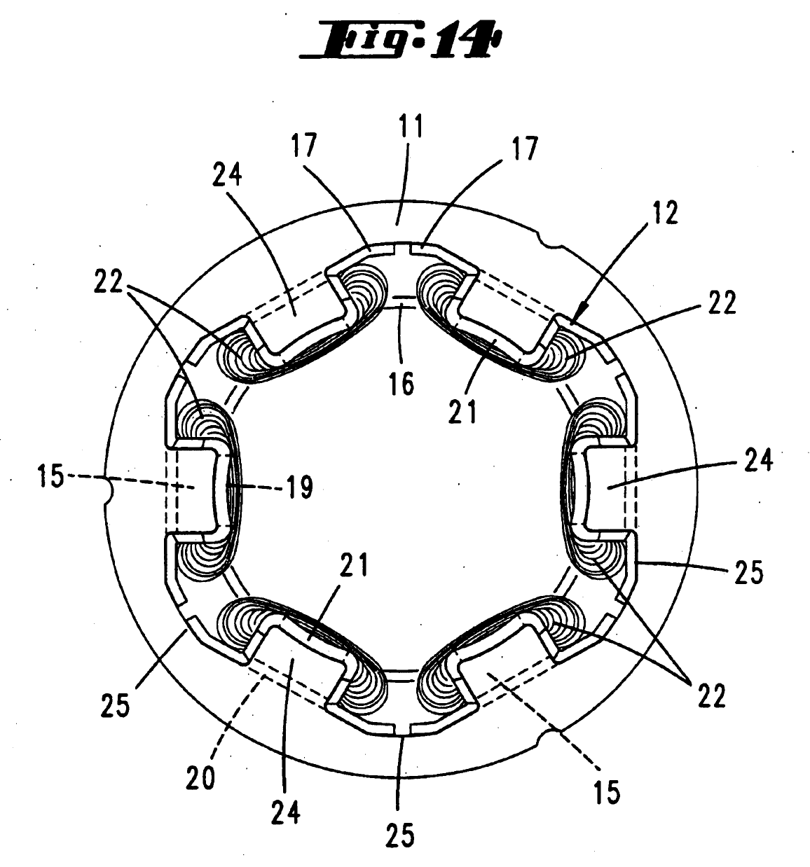

FIG. 9 shows a side view of a stator core;

FIG. 10 shows a side view of a lower bearing part which can be associated with the stator core and the stator covering body;

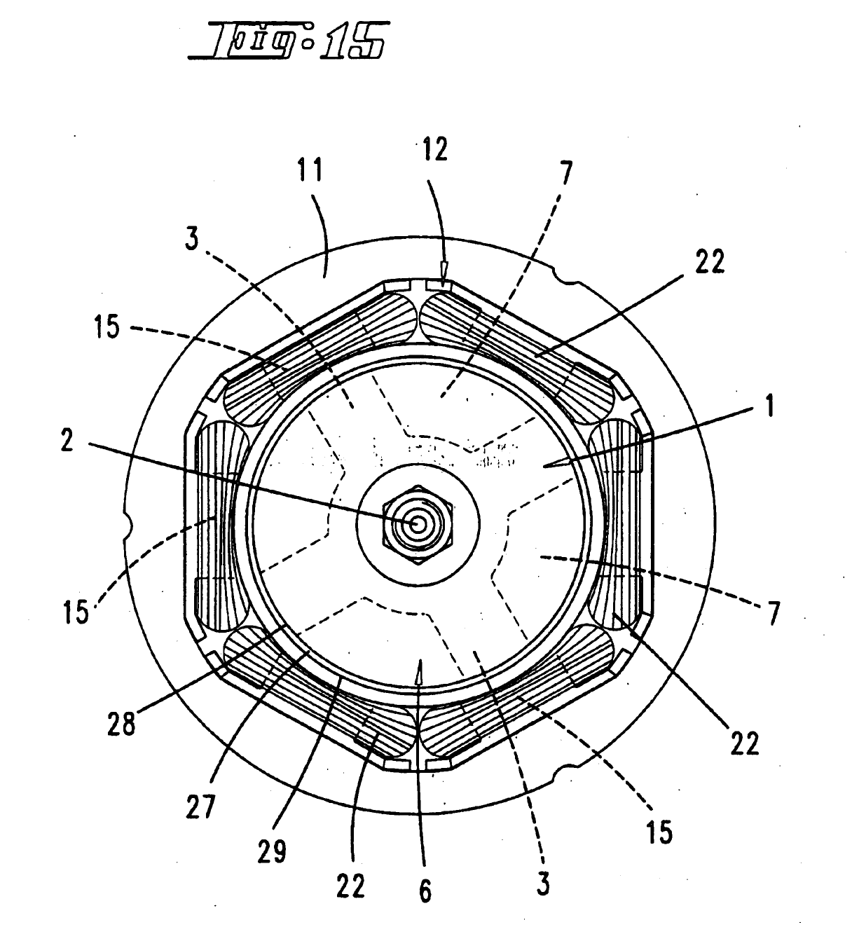

FIG. 11 shows the side view of an upper bearing part;

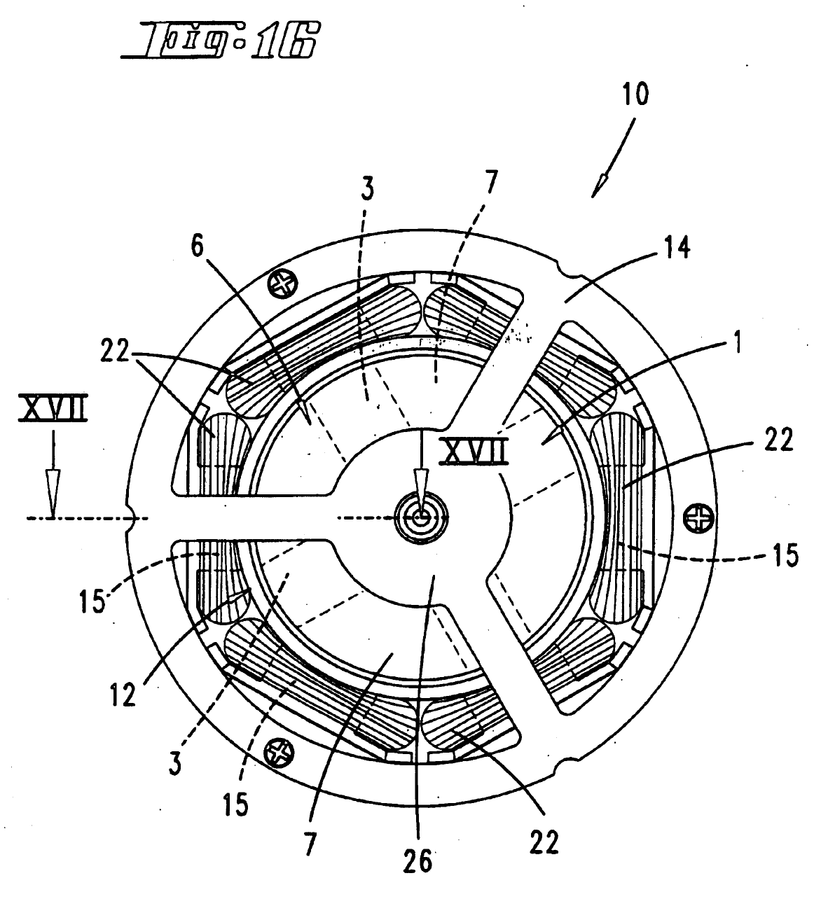

FIG. 12 shows the end view toward the stator covering body;

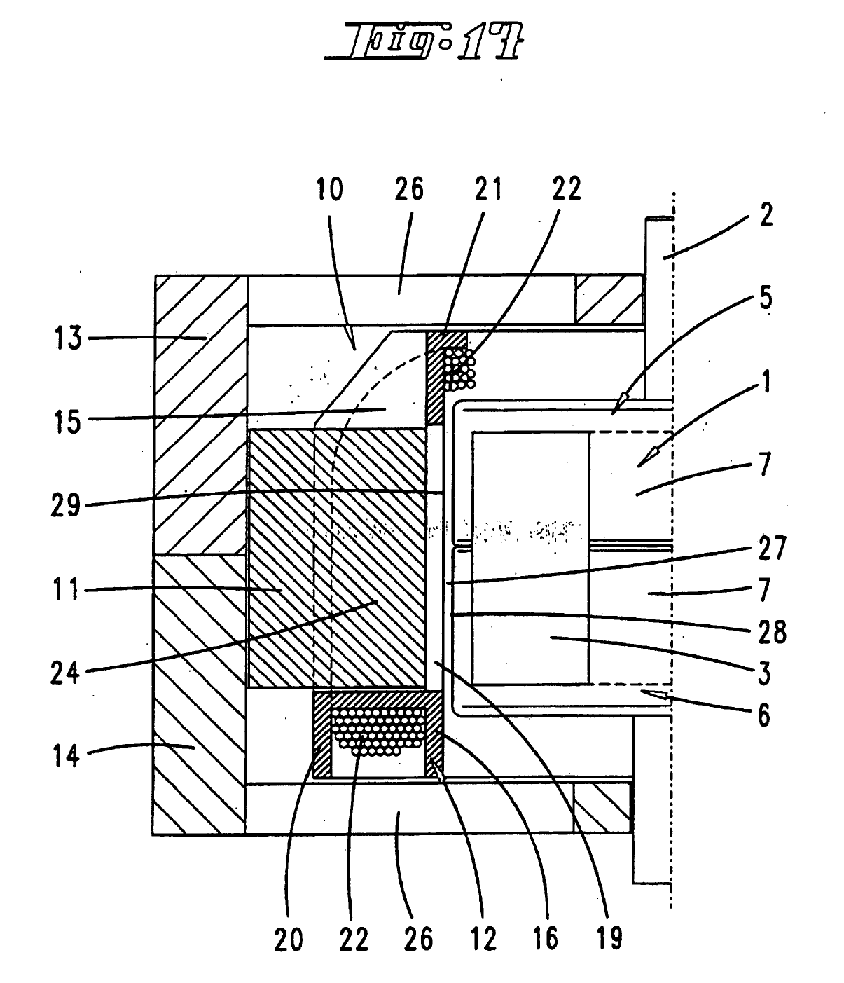

FIG. 13 shows a representation corresponding to FIG. 12, but after stator coils have been disposed on the stator covering body;

FIG. 14 shows the end view toward the stator covering body provided with the windings, after said body has been inserted into the stator core;

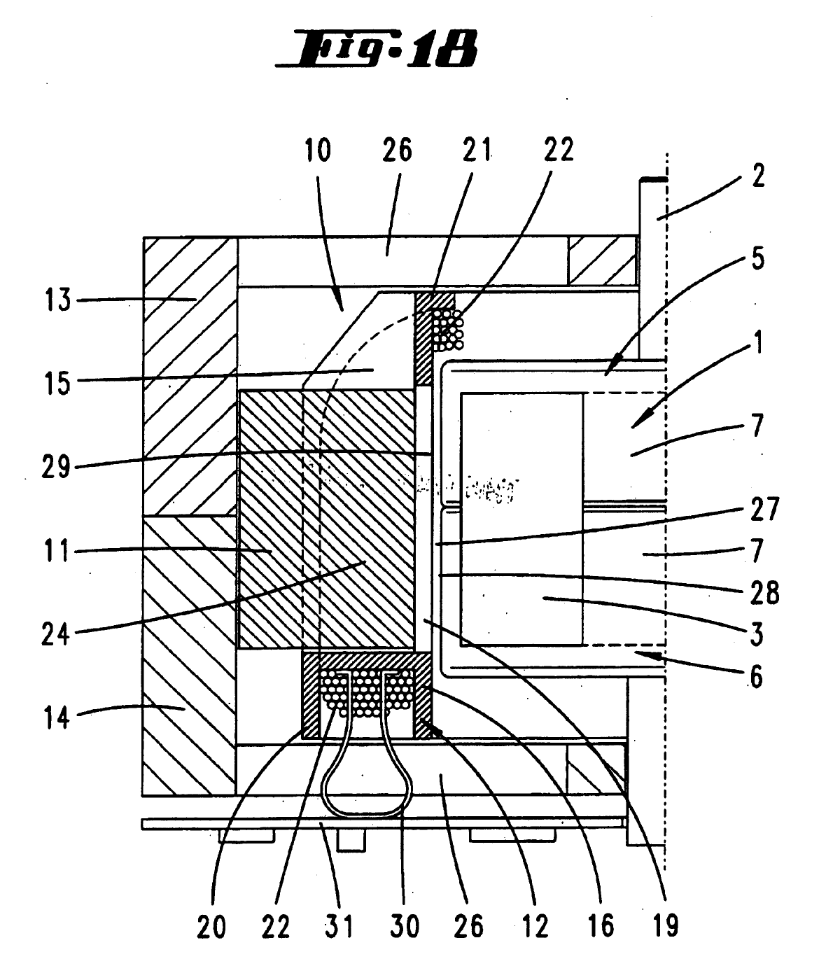

FIG. 15 shows the rear view toward the stator covering body provided with windings and pushed into the stator core, with the rotor inserted into the stator;

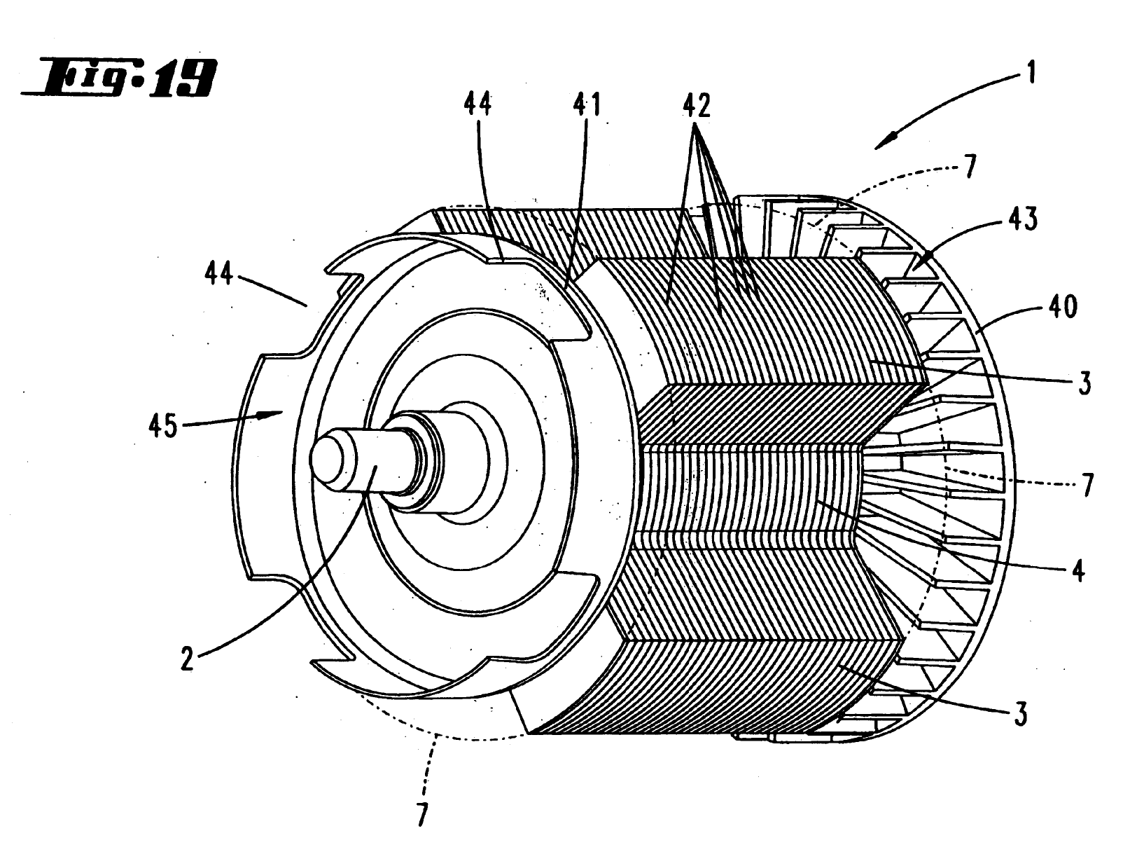

FIG. 16 shows a representation corresponding to FIG. 15, but after complete mounting of the reluctance motor, i.e. after the lower and upper bearing parts have been positioned;

FIG. 17 shows the section according to the line XVII-XVII in FIG. 16;

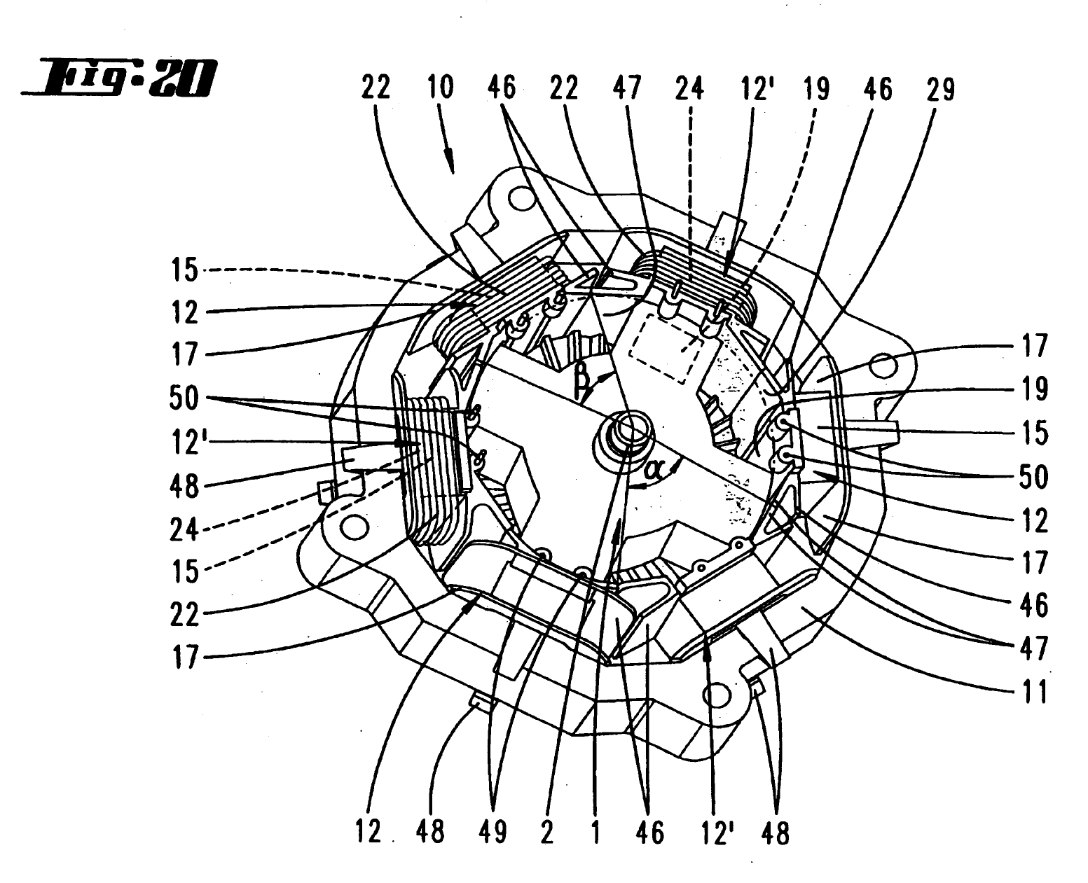

FIG. 18 shows a sectional representation corresponding to FIG. 17, but relating to a further embodiment;

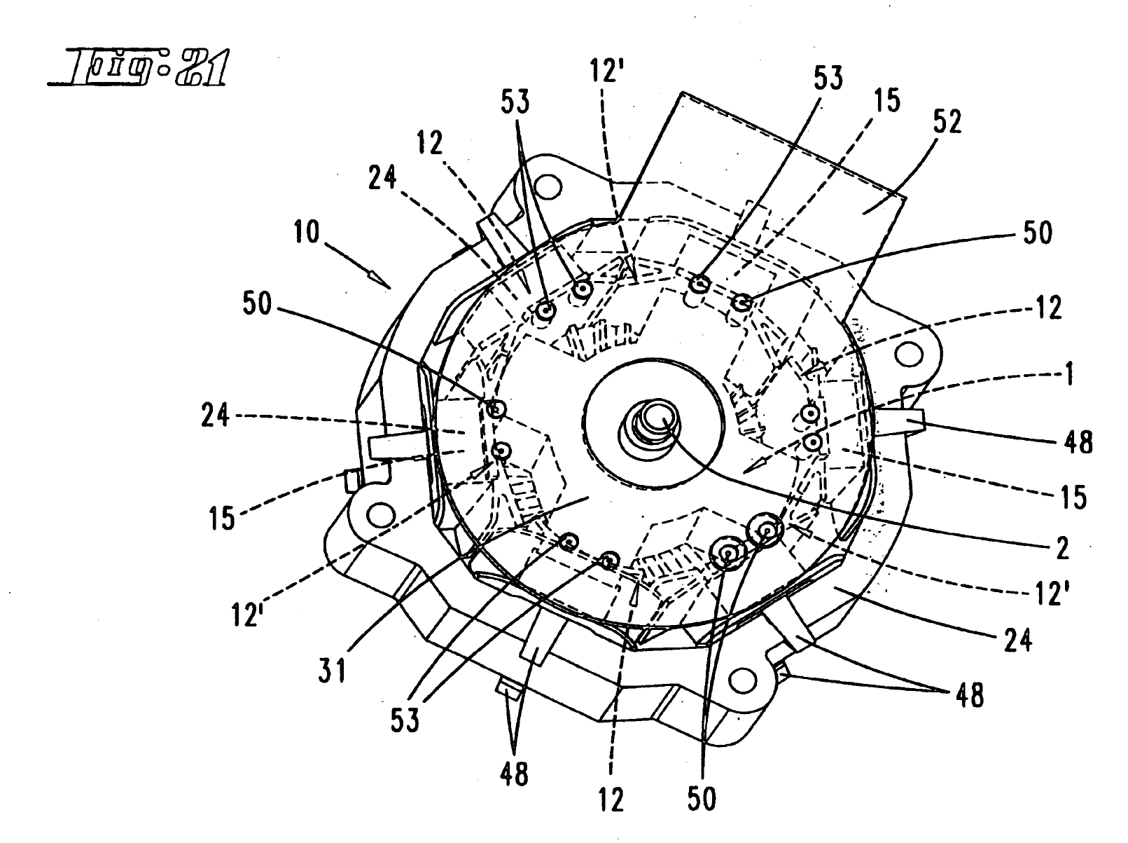

FIG. 19 shows a perspective representation of a rotor, in respect of a further embodiment;

FIG. 20 shows a perspective representation of a stator in a further embodiment, with a rotor according to the embodiment in FIG. 19;

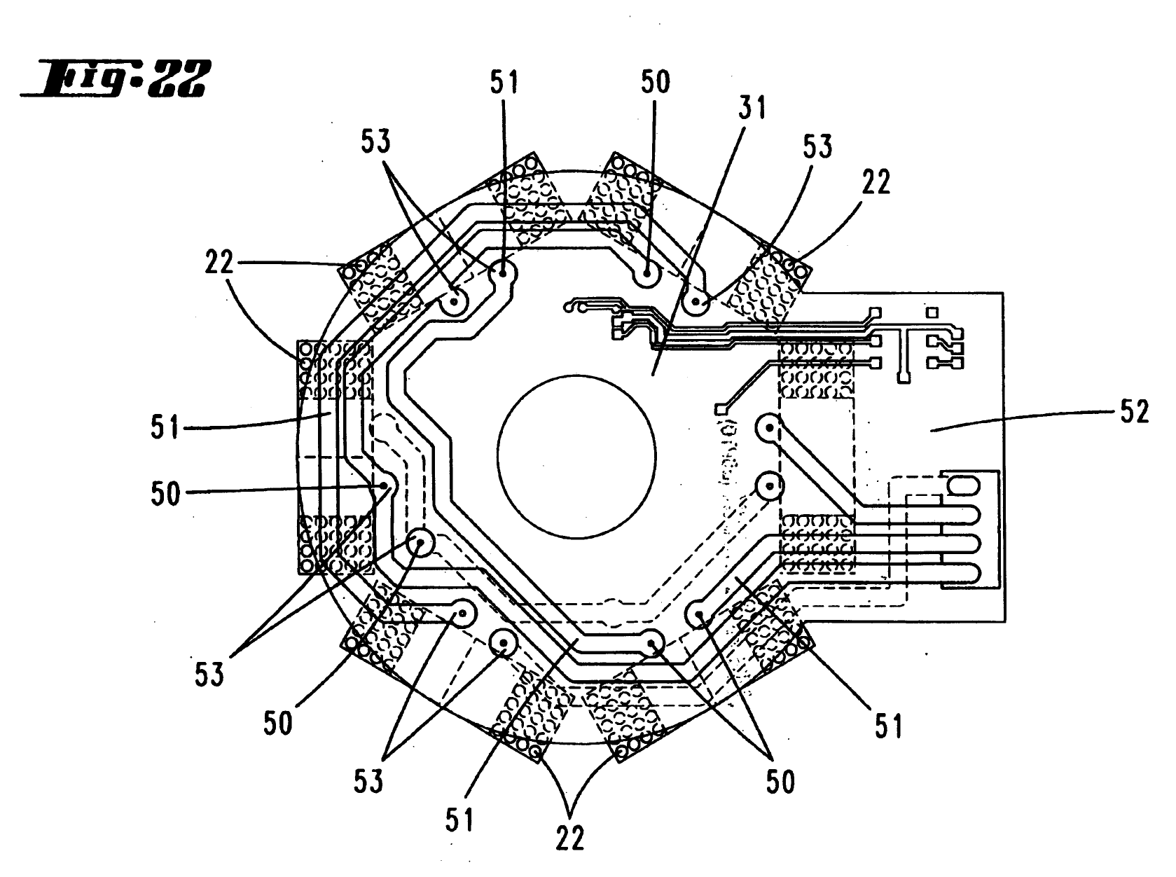

FIG. 21 shows a representation corresponding to FIG. 20, after-a printed circuit board has been positioned;

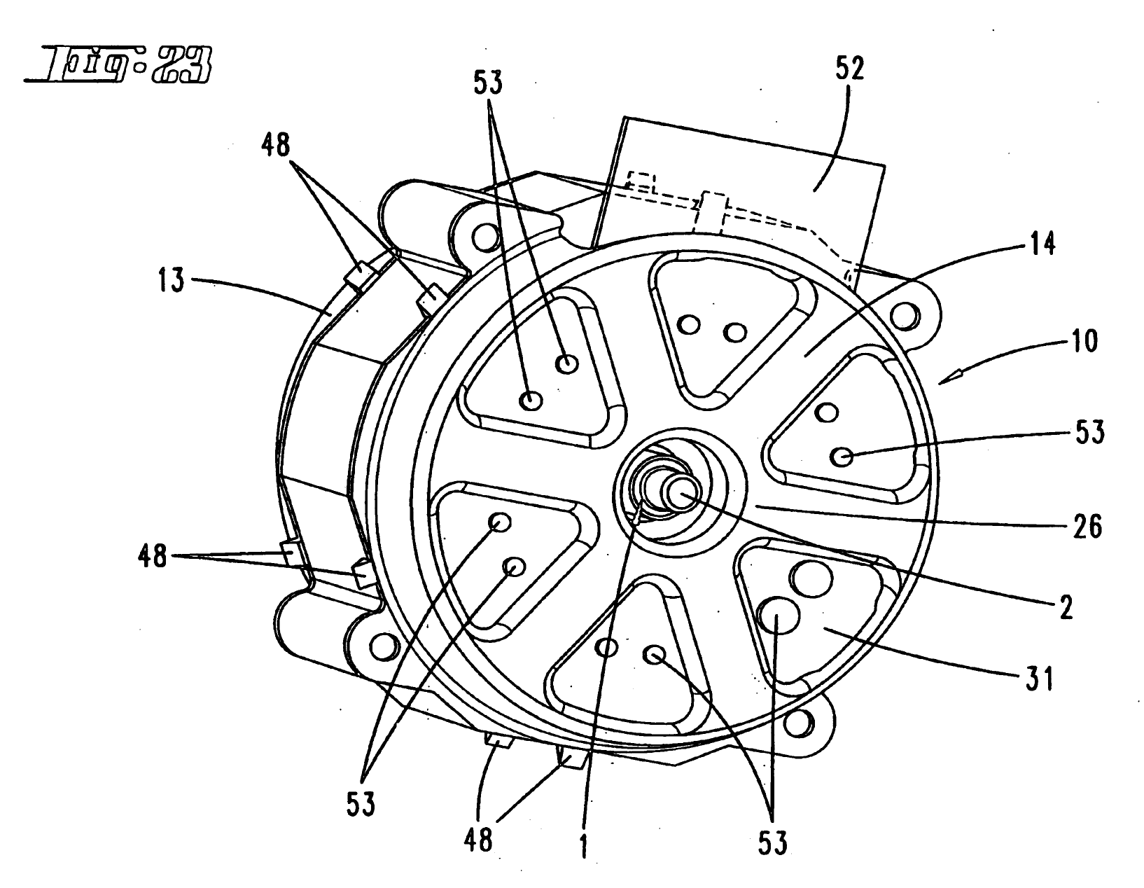

FIG. 22 shows the printed circuit board in an individual representation with schematically indicated stator coils;

FIG. 23 shows a representation corresponding to FIG. 21, after bearing bridges for the rotor have been placed in position.

Presented and described in the first instance with reference to FIG. 1 is a rotor 1 with an axial rotor body 2 and four rotor segments 3 disposed at equal angles around the axial rotor body, with gaps 4 remaining between the rotor segments 3 as shown in FIG. 4.

To reduce the sound emission, the gaps 4 between the wing-like rotor segments 3 are filled to create a cylindrical body. For this purpose, two cladding parts 5, 6 which can be axially fitted together are provided, each cladding part 5, 6 having filling segments 7 formed in a way corresponding to the cross section of the gaps 4.

As can be seen from the individual representations, the cladding parts 5, 6 are formed in a pot-like manner, with a circular disk part 8 and four filling body segments 7 extending from the latter. It is preferred for the cladding parts 5, 6 to be formed as plastics parts, further preferred for them to be formed as injection moldings of plastic.

The two cladding parts 5, 6, receiving the rotor 1 between them, are pushed over the axial rotor body 2 and are axially braced together by means of screws 9.

This creates a rotor 1 in the form of a cylindrical body as shown in FIG. 7, whereby pressure variations during rotation of the rotor in the stator are effectively suppressed. The sound emission is distinctly reduced as a result. The filling body segments 7 can also be used at the same time for balancing the rotor 1. When the filling body segments 7 are configured as injection moldings of plastic, any desired forms or structures can also be produced in their surfaces. By forming in a suitable way, a kind of cooling fan can also be created.

The stator 10 of the reluctance motor according to the invention is substantially made up of a stator core 11, a stator covering body 12 which can be inserted in the latter, a lower bearing part 13 and an upper bearing part 14.

The stator covering body 12 is substantially formed as a hollow cylinder and has a number of wound core shoes 15 corresponding to the number of coils, said wound core shoes being disposed substantially on the outside of a basic cylindrical body 16, aligned parallel to the body axis of the stator covering body 12.

The wound core shoes 15 have over the majority of their axially measured length approximately tangentially pointing-away wings 17, the wings 17 of two neighboring wound core shoes 15 that point toward each other being spaced apart from each other and leaving a gap 18.

The wound core shoes 15 are formed in a substantially U-shaped manner in cross section, the tangentially outwardly pointing wings 17 being disposed at the ends of the U legs. The U piece connecting the U legs is formed substantially by the basic body 16, with the basic body 16 or the U piece of each wound core shoe 15 having in the region of the wound core shoes 15 an aperture in the form of a window 19. As a consequence of this, the U opening of each wound core shoe 15 is extended toward the interior of the stator covering body 12.

On the bottom side, each and every wound core shoe 15 is provided with a further wing 20, which like the wings 17 is spaced apart radially from the basic body 16.

Lying opposite this wing 20 on the bottom side, the associated wound core shoe 15 extends in the axial direction beyond the basic body 16 and respectively forms an angled-away winding overhang 21, pointing into the interior of the stator covering body.

As a consequence of this configuration of the stator covering body 12, the latter serves in the first instance as a coil former. This is wound in a way similar to in the case of a rotor of a universal motor. The stator windings 22 wound on in the simplest way enclose the respective wound core shoes 15 in the region of the wings 17 and 20 disposed on the latter, these wings 17, 20 serving for securely holding the stator windings 22 on the wound core shoe 15. In the region of the end of each wound core shoe 15 on the top side, the stator windings 22 are passed over the inwardly angled-away winding overhang 21, whereby the windings 22 protrude into the interior of the stator covering body 12 beyond the inside diameter of the basic body 16 (cf. FIG. 13).

Along with the advantage of a significantly simplified stator winding technique, there is obtained the advantageous effect that the stator covering body 12 causes the spaces between the stator windings 22 to be filled by a body formed by the basic body 16, which in addition to the forming of the rotor 1 as a cylindrical body, as described above, contributes to reducing the sound emission.

The stator covering body 12, represented in FIG. 13 and provided with stator windings 22, is pushed in an extremely simple way from one side in the axial direction into the stator core 11 in such a way that wound cores 24 are pushed into the U spaces of the wound core shoes 15 from the top side of the wound core shoes 15 that has the winding overhang 21. The portions of the stator covering body 12 bounded by the wings 17 and passed through by stator windings 22 enter into correspondingly formed clearances 25 in the stator core 11, which are aligned parallel to the body axis (cf. FIG. 14).

The chosen way in which the stator winding 22 is arranged such that it is angled away and at the top side, where it is passed over the winding overhang 21, protrude into the interior of the stator covering body 12, makes it possible for the wound-around stator covering body 12 to be pushed into the stator core 11.

Furthermore, it is possible, but not shown, for the stator covering body 12 to have formed or attached on one side a -bearing receptacle in the form of a bridge for the rotor 1. However, there is also the possibility, as represented, of providing the lower bearing part 13 or the upper bearing part 14 with such a bridge 26, having a bearing receptacle.

As can be seen from the representation in FIG. 15, after the rotor 1 assembled as shown in FIGS. 1 to 7 has been pushed into the interior of the stator covering body 12, an annular space 27 is formed between the rotor outer surface 28 and the inner stator surface 29, a substantially smooth-faced surface 28, 29 being respectively formed by spaces between the stator windings 22 and between the rotor segments 3 being filled with filling segments 7 and 16, respectively. As a consequence of this, both the rotor surface 28 and the inner stator surface 29 are made more homogeneous, whereby pressure variations during rotation of the rotor 1 in the stator 10 are effectively suppressed.

An alternative configuration is represented in FIG. 18, in which a bow spring contact 30 is attached on a wound core shoe 15. This shows that the bow spring contact 30 is disposed on the bottom side in a U space which is bounded at the sides by the wing 20 and the basic body 16, is free in the downward direction and is passed through by the stator windings 22. The bow spring contact 30 is correspondingly contacted on the bottom side directly by the stator windings 22.

On the upper side, the bow spring contact 30 contacts a printed circuit board 31, on which position sensors for the rotor 1 and/or conversion electronics for changing the driving direction of the motor to counterclockwise or clockwise are disposed.

In FIG. 19, an alternative configuration of the rotor 1 is represented. The holding disks 40, 41, between which the rotor laminations 42 are secured, each undertake a dual function in this embodiment. For instance, the holding disk 40 is formed at the same time as a cooling fan 43, with a diameter which approximately corresponds to the rotor diameter in the region of the rotor segments 3.

The holding disk 41 lying opposite this cooling fan 43 is shaped in a substantially hollow-cylindrical manner, with segments 44 being cut free in the region of the cylinder wall. As a result, the holding disk 41 at the same time forms a sensor disk 45, for interacting with a light barrier, which is located on the printed circuit board 31. The sensor disk 45 has in this case a uniquely defined association with the position of the rotor. Since the position of the rotor 1 is definitively determined by the bridges 26 of the lower bearing part 13 and upper bearing part 14, the distance between the sensor disk 45 and the printed circuit board 31 is likewise automatically set.

Furthermore, it is also possible in the case of this embodiment for the gaps 4 between the wing-like rotor segments 3 to be filled with filling segments 7, indicated by dash-dotted lines in FIG. 19.

A further embodiment, for creating a homogeneous inner stator surface 29, is represented in FIG. 20. In this case, a plurality of stator covering bodies 12, 12′ are provided, substantially making up a cylinder on the rotor side. Each stator covering body 12, 12′ is formed as an individual coil former, with a wound core shoe 15. The latter has in the direction of the rotor 1 an aperture in the form of a window 19, in which the metal wound core is exposed on the rotor side.

Furthermore, the stator covering body 12, 12′ is formed in base outline in an approximately H-shaped manner, the H piece connecting the H legs being formed by the wound core shoe 15. The H legs form on either side of the wound core shoe 15 wings 17 and 46, respectively, in which gap formed as a result the stator windings 22 are fitted.

The wings 17 and 46 are aligned substantially parallel to each other, with furthermore two wings 46 of two neighboring stator covering bodies 12, 12′ covering over the gap between the stator windings 22 in the installation position as shown in FIG. 20.

Disposed in front of the wings 46 on the rotor side, on the stator covering bodies 12, there are cover segments 47 which are angled away from the wings 46 and in the base outline of the stator covering body 12, 12′ combine with the end face of the wound core shoe 15 on the rotor side to form approximately a segment of a circle.

The stator covering bodies 12, 12′ formed in this way, with the applied stator windings 22, are clipped radially outward from the inner stator side onto the stator core 11 by means of resilient tongues 48, with collision-free mounting being ensured by providing two different coil formers or stator covering bodies 12 and 12′, the rounded portions of which fill different segments of a circle in the region of the cover segments 47. For instance, the stator covering bodies 12′ form a larger segment of the inner stator surface over an angle alpha than the stator covering bodies 12 (angle beta).

1. A method for controlling a reluctance motor comprising a rotor (1) and a stator (10), the stator (10) having individual stator coils (22) and a predefined current flowing in the coils (22) according to the loading of the motor, characterized in that different control methods are applied, depending on the number of revolutions of the rotor (1), to be specific by prescribing a fixed rotary field when the number of revolutions is relatively small.

2. The method as claimed in claim 1 or in particular as claimed therein, characterized in that, at higher rotational speeds, a current hysteresis control method is applied.

3. The method as claimed in one or more of the preceding claims or in particular as claimed therein, characterized in that, when prescribing a rotary field, the rotor current is adapted or reduced to an adequate value.

4. The method as claimed in one or more of the preceding claims or in particular as claimed therein, characterized in that, with the current hysteresis control method, the windings (22) are switched on and off by means of sensors detecting the rotor position.

5. The method as claimed in one or more of the preceding claims or in particular as claimed therein, characterized in that the predefined current is achieved by impressing on a constant voltage and in that, when the voltage is impressed, the time it takes to reach the maximum current value is measured, as a measure of the loading of the motor.

6. The method as claimed in one or more of the preceding claims or in particular as claimed therein, characterized in that the predefined current is retained by switching a positive voltage off and on.

7. The method as claimed in one or more of the preceding claims or in particular as claimed therein, characterized in that, when a limit current-for preventing a motor overload is reached, a reduction in rotational speed takes place.

8. The method as claimed in one or more of the preceding claims or in particular as claimed therein, characterized in that the time measurement takes place by starting an internal counter when the voltage is switched on and stopping the counter when a maximum current value is exceeded.

9. The method as claimed in one or more of the preceding claims or in particular as claimed therein, characterized in that, triggered by reaching a minimum counter value, a speed reduction is controlled.

10. The method as claimed in one or more of the preceding claims or in particular as claimed therein, characterized in that a control of the stator currents takes place according to the measured time.

11. The method as claimed in one or more of the preceding claims or in particular as claimed therein, characterized in that, the predefined current is variable.

12. The method as claimed in one or more of the preceding claims or in particular as claimed therein, characterized in that the predefined current is steplessly variable.

13. The method as claimed in one or more of the preceding claims or in particular as claimed therein, characterized in that the control of the stator currents takes place by means of a converter.

14. The method as claimed in one or more of the preceding claims or in particular as claimed therein, characterized in that the rotor position is determined by means of a reflected light barrier, the reflection of the rotor (1) being used directly for measurement by alignment of the light source with the rotor (1).

15. The method as claimed in one or more of the preceding claims or in particular as claimed therein, characterized in that a position sensor is provided for each phase.

16. The method as claimed in one or more of the preceding claims or in particular as claimed therein, characterized in that no phase is supplied with current any longer when backward turning of the rotor (1) commences.

17. The method as claimed in one or more of the preceding claims or in particular as claimed therein, characterized in that, when backward turning is initiated, the last phase is supplied with current for an extended period.

18. A method for controlling a reluctance motor comprising a rotor (1) and a stator (10), the stator (10) having individual stator coils (22) and a predefined current flowing in the coils (22) according to the loading of the motor, characterized in that a temperature registration by means of a temperature sensor takes place at the stator winding (22).

19. The method as claimed in claim 18 or in particular as claimed therein, characterized in that the temperature sensor is an NTC.

20. The method as claimed in claims 18 or 19 or in particular as claimed therein, characterized in that, when a temperature limit is exceeded, the motor is switched off or the phase current is limited.

21. A method for controlling a reluctance motor comprising a rotor (1) and a stator (10), the stator (10) having individual stator coils (22) and a predefined current flowing in the coils according to the loading of the motor, characterized in that the motor can be driven both counterclockwise and clockwise.

22. A reluctance motor comprising a rotor (1) and a stator (10), the stator (10) having individual stator coils (22) and the rotor (1) having wing-like rotor segments (3), characterized in that the gaps (4) between the wing-like rotor segments (3) are filled to create a cylinder body.

23. The reluctance motor as claimed in claim 22 or in particular as claimed therein, characterized in that the filling takes place by means of two cladding parts (5, 6) which can be axially fitted together and have filling segments (7).

24. The reluctance motor as claimed in one or more of claims 22 or 23 or in particular as claimed therein, characterized in that a cladding part (5, 6) has filling body segments (7) extending from a circular disk part (8).

25. The reluctance motor as claimed in one or more of claims 22 to 24 or in particular as claimed therein, characterized in that the filling body segments (7) are plastics parts.

26. The reluctance motor as claimed in one or more of claims 22 to 25 or in particular as claimed therein, characterized in, that the gap between the stator windings (22) is filled by a stator covering body (12).

27. The reluctance motor as claimed in one or more of claims 22 to 26 or in particular as claimed therein, characterized in that the stator windings (22) are covered on the rotor side, with a gap between the stator windings (22) being covered over.

28. The reluctance motor as claimed in one or more of claims 22 to 27 or in particular as claimed therein, characterized in that the stator covering body (12) is formed as a cylinder.

29. The reluctance motor as claimed in one or more of claims 22 to 28 or in particular as claimed therein, characterized in that a plurality of stator covering bodies (12) are provided, making up a cylinder on the rotor side.

30. The reluctance motor as claimed in one or more of claims 22 to 29 or in particular as claimed therein, characterized in that stator covering bodies (12) with rotor-side cover segments (47) of different sizes, covering over the gap between the stator windings (22), are provided.

31. The reluctance motor as claimed in one or more of claims 22 to 30 or in particular as claimed therein, characterized in that the stator covering body (12) has windows (19), in which the metallic wound cores (24) are exposed on the rotor side.

32. The reluctance motor as claimed in one or more of claims 22 to 31 or in particular as claimed therein, characterized in that the stator covering body (12) has wound core shoes (15), which carry the windings (22).

33. The reluctance motor as claimed in one or more of claims 22 to 32 or in particular as claimed therein, characterized in that the windings (22) are formed on one side such that they protrude into the interior of the space bounded by the stator (10).

34. The reluctance motor as claimed in one or more of claims 22 to 33 or in particular as claimed therein, characterized in that the stator covering body (12) has formed or attached on one side of it a bearing receptacle for the rotor (1).

35. The reluctance motor as claimed in one or more of claims 22 to 34 or in particular as claimed therein, characterized in that a bow spring contact (30), which is contacted directly by the winding (22) on the bottom side, is attached to the wound core shoe (15).

36. The reluctance motor as claimed in one or more of claims 22 to 35 or in particular as claimed therein, characterized in that the bow spring contact (30) is contacted with a printed circuit board (31) on the upper side.

37. The reluctance motor as claimed in one or more of claims 22 to 36 or in particular as claimed, therein, characterized in that a winding (22) has contacts which directly contact a printed circuit board (31).

38. The reluctance motor as claimed in one or more of claims 22 to 37 or in particular as claimed therein, characterized in that each winding (22) has two terminal pins (50), which contact with a printed circuit board (31).

39. The reluctance motor as claimed in one or more of claims 22 to 38 or in particular as claimed therein, characterized in that the printed circuit board (31) is aligned parallel to the rotor laminations (42).

40. The reluctance motor as claimed in one or more of claims 22 to 39 or in particular as claimed therein, characterized in that the printed circuit board (31) is disposed in a rotationally fixed manner between the rotor (1) and a bearing receptacle for the rotor (1).

41. The reluctance motor as claimed in one or more of claims 22 to 40 or in particular as claimed therein, characterized in that the printed circuit board (31) has a circular disk-shaped base outline with a terminal portion (52) protruding outward beyond the stator core (11), the circular disk-shaped base outline being adapted in diameter to the inside diameter of the stator core (11).

42. The reluctance motor as claimed in one or more of claims 22 to 41 or in particular as claimed therein, characterized in that the printed circuit board (31) has the position sensors for the rotor (1).

43. The reluctance motor as claimed in one or more of claims 22 to 42 or in particular as claimed therein, characterized in that the printed circuit board (31) has the direction-changing electronics.

44. The reluctance motor as claimed in one or more of claims 22 to 43 or in particular as claimed therein, characterized in that a holding disk (41) of the rotor laminations (42) is formed as a sensor disk (45) for the determination of the rotor position.

45. The reluctance motor as claimed in one or more of claims 22 to 44 or in particular as claimed therein, characterized in that the sensor disk (45) is disposed on the rotor (1) such that it faces the printed circuit board (31).

46. The reluctance motor as claimed in one or more of claims 22 to 45 or in particular as claimed therein, characterized in that a holding disk (40) of the rotor laminations (42) is formed as a cooling fan (43).

47. The reluctance motor as claimed in one or more of claims 22 to 46 or in particular as claimed therein, characterized in that the cooling fan (43) is formed on the end of the rotor (1) remote from the printed circuit board (31).
